(19) United States
(12) Patent Application Publication
(10) Pub. No.: US 2012/0029268 A1
(43) Pub. Date: Feb. 2, 2012

(54) MAGNETOFLUIDIC HEARING AID SYSTEM AND HEARING AID

(75) Inventors: Matthias Mueller-Wehlau, Erlangen (DE); Andreas Tiefenau, Zaandam Noord Holland (NL)

(73) Assignee: SIEMENS MEDICAL INSTRUMENTS PTE. LTD., Singapore (SG)

(21) Appl. No.: 13/263,869

(22) PCT Filed: Mar. 31, 2010
(86) PCT No.: PCT/EP2010/054371

§ 371 Date: Oct. 11, 2011

(30) Foreign Application Priority Data
Apr. 8, 2009 (DE) 10 2009 016 843.5

(51) Int. Cl. H04R 25/00

(52) U.S. Cl. 600/25

(57) ABSTRACT

A magnetofluidic hearing aid system includes a hearing aid having a signal processing device connected to a magnetic transmitter. The system includes such a hearing aid and a magnetofluid suitable for use in the body. The magnetic transmitter transmits a magnetic field producing vibrations in a liquid mixture containing the magnetofluid. The liquid mixture is operatively introduced into a cochlea, and the vibrations are suitable for triggering an auditory perception in the cochlea. Acoustic feedback is precluded as a result of the transmitter producing neither acoustic signals nor mechanical vibrations. A functional impairment caused by physical influences such as soiling, for example, of an acoustic receiver, is also precluded. Problems arising from impaired contact with the body are prevented from the beginning by the non-contact signal transmission. A hearing aid supply is also advantageously enabled regardless of the functional capability of the middle ear apparatus.

The invention relates to a magnetofluidic hearing-aid system comprising a hearing aid and a magnetofluid, and to a hearing aid for use in such a hearing-aid system.

Hearing aids serve to treat damaged hearing or loss of hearing of persons who are hard of hearing. In addition to the treatment of loss of hearing, which is also referred to as hearing loss, hearing aids also treat damaged hearing in the form of misperceptions, e.g. tinnitus. Instruments for treating tinnitus may inter alia be so-called tinnitus maskers. In the following text, the term hearing aid mainly describes embodiments for treating hearing loss; however, it should equally be understood to include other instruments for treating damaged hearing.

There are different types and severities of hearing loss or damaged hearing. These are usually treated by so-called hearing aids. The hearing aids can be used in different categories or housing shapes, wherein the housing shape to be used is also directed to the type and extent of the damage to the hearing. By way of example, so-called behind-the-ear (BTE) aids, completely-in-canal (CIC) aids, and receiver-in-canal (RIC) aids are known. Furthermore, instruments that have been completely or partly implanted and directly stimulate the hearing nerves electrically, e.g. so-called cochlea implants, are also known.

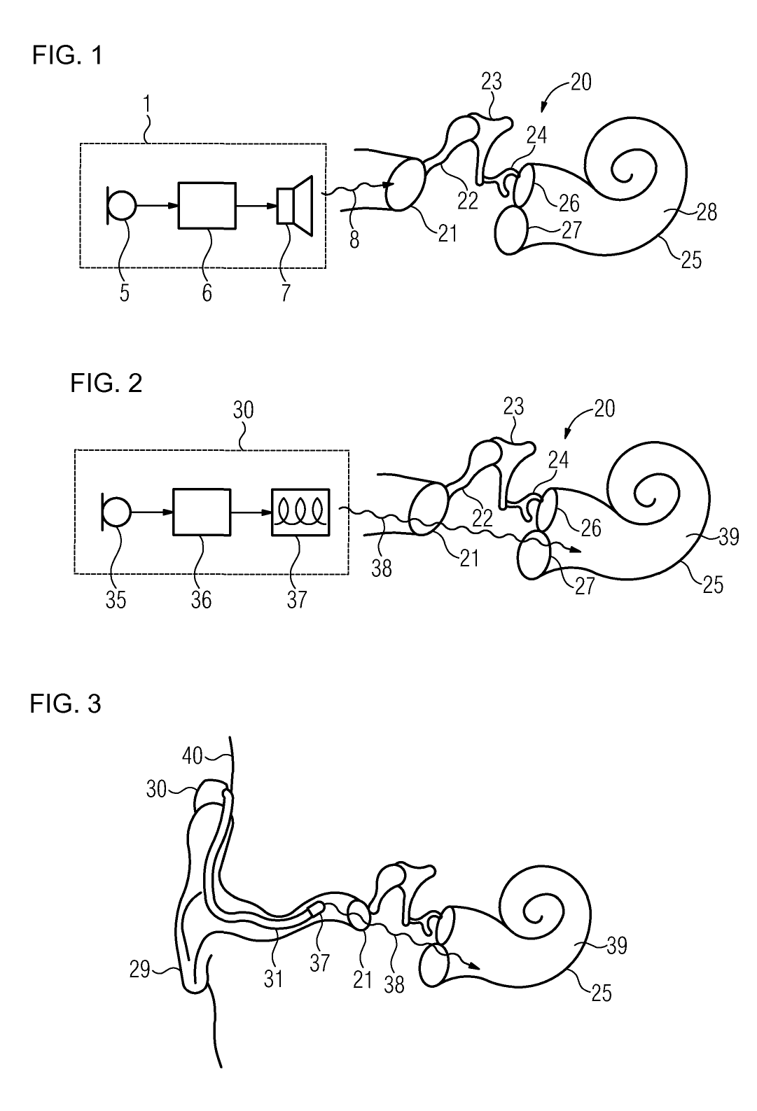

In principle, hearing loss is treated by means of a hearing aid using the components illustrated in FIG. 1. The hearing aid 1 comprises a microphone 5 for recording acoustic signals from the surroundings and converting them into electric signals. The electric signals are transmitted to a signal processing device 6, which undertakes processing dependent on hearing aid settings or hearing damage of the hearing-aid user. In the case of hearing aids for treating misperceptions, it may be possible to dispense with the microphone 5 in certain circumstances.

The signal processing device 6 generates a processed, in general mainly amplified, output signal, which is routed to the receiver 7. The receiver 7 converts the electric signal into sound waves, which are illustrated in the figure as a snaking arrow 8.

The sound waves generated by the receiver 7 are routed to the eardrum 21 of the hearing-aid user. From there, they reach the cochlea 25, which is also referred to as “Schnecke” [snail] in German due to its shape, via the components of the hearing apparatus 20, namely the malleus 22, incus 23 and stirrup 24. The stirrup 24 actuates the so-called oval window 26 of the cochlea 25 with mechanical pulses that were generated by sound waves, as a result of which vibration states that are perceptible in auditory terms are generated in the bodily fluid 28 that fills the cochlea 25. The bodily fluid 28 is endolymph or perilymph, which is situated in a system made of a number of tubes. The organ of Corti with the so-called hair cells that bring about auditory perception is situated in the tube system filled with perilymph. The tube and fluid system of the cochlea 25 furthermore comprises the so-called round window 27. Apart from that, there is presently no need for a further detailed illustration.

The mode of action of a conventional, usual hearing aid is therefore, in principle, based on the stimulation of the hearing apparatus by sound waves in a fashion conventional for the hearing apparatus, merely with modified acoustic signals or volumes. A typical problem, which is inherent in this mode of action, is the risk of so-called feedback, i.e. acoustic feedback. In the process, signals from the receiver 7 reach and couple into the microphone 5 of the hearing aid via sound or solid-borne sound transmission. As a result, positive feedback is generated, which is usually expressed as a loud whistle and is very uncomfortable for the hearing-aid user.

This problem increases with increasing acoustic amplification by the hearing aid and therefore occurs particularly in hearing aids for treating severe losses.

Specific housing shapes or hearing-aid concepts can help to reduce the risk of feedback. By way of example, use can be made of a sealed solution, in which the auditory canal is completely sealed by the hearing aid or sealed with only the exception of a small ventilation opening (vent). However, sealing the auditory canal goes hand in hand with so-called occlusion effects, which result in a disassociation of the hearing-aid user's own voice and sound perception, which hearing-aid users perceive as an annoyance. Other housing shapes, e.g. arranging the receiver in the auditory canal, which remains open, and arranging the microphone behind the ear, can likewise reduce the tendency for feedback but are just as unable to eliminate it.

A further problem of conventional hearing aids lies in the reduction in the functionality of the receiver during constant operation. The receiver can be damaged or adversely affected by weather influences, humidity or sweat, and earwax. Hence constant use of the receiver without cleaning or the occasional replacement by a new part has proven to be impossible.

The document U.S. Pat. No. 5,176,620 has disclosed a hearing-aid system that operates without acoustic receivers in the conventional sense. An otherwise conventional hearing aid has a transmitter in place of the receiver, which transmitter does not transmit acoustic vibrations to the eardrum but rather directly to the cochlea. The transmitter is implanted in the human hearing apparatus and directly connected to the round window of the cochlea. Its functionality is based on the use of a liquid for transmitting the acoustic vibrations. The vibrations are generated by a transducer, e.g. a loudspeaker, transmitted to the liquid and thereby routed to the cochlea and transmitted thereto. In this known hearing aid, acoustic feedback is unlikely since no acoustic signal is generated which could reach the microphone by sound transmission and be coupled therein. However, transmission from the transducer to the microphone by solid-borne sound is possible. The durability of the transmitter is limited because the connection between transmitter and cochlea can be subject to biological processes of change, e.g. growing and scarring, and can be adversely affected by body media.

The document U.S. Pat. No. 6,436,028 B1 discloses a system for moving auditory ossicles, in which a magnetic material is connected to the epithelium of the auditory ossicles using. The magnetic material comprises magnetic microbeads that experience a driving force via a magnetic transmitter.

The document U.S. Pat. No. 6,137,889 A discloses a device for directly exciting the eardrum. A vibration generator is connected directly to the eardrum and transmits vibrations directly to the latter.

The document DE 10 2007 031 114 A1 discloses an implantable hearing system for direct or indirect hydrodynamic coupling to the perilymph space in the human ear. Here, an actuator transmits vibration signals to the perilymph. The actuator has a sheath, which is filled with an electromagnetic liquid and changes its spatial extent if an external voltage is applied.

The textbook Ulrich, J., Hoffmann, E., Hörakustik—Theorie and Praxis [Hearing acoustics—theory and practice], 1^{st} edition, Heidelberg, DOZ Verlag [Publishers], 2007, page 1225 (ISBN 978-3-922269-80-9) discloses that nano-filling-bodies do not have an amorphous structure but behave like liquids.

Further approaches for suppressing feedback and fighting against the occlusion effects are known, which for example can be implemented in analog or digital signal processing. What is common to all known approaches is that their reaction time is not sufficiently fast, they falsify useful acoustic signals or otherwise adversely affect the sound impression for the hearing-aid user.

The invention is based on the object of developing a hearing aid and a system using such a hearing aid, in which feedback is prevented, occlusion effects are avoided and the durability of the transmitter is improved.

The invention solves this problem by means of a hearing aid and a system with the features of the independent patent claims.

A basic idea of the invention consists of a system consisting of a hearing aid and a magnetofluid, wherein the hearing aid comprises a signal processing device and a magnetic transmitter connected thereto, and wherein the magnetofluid interacts with the hearing aid via a magnetic field. As per this basic idea, the magnetofluid is suitable for use within a human body, and the magnetic transmitter transmits a magnetic field, by means of which vibrations, which are suitable for triggering an auditory perception in a human cochlea, are generated in a liquid mixture containing the magnetofluid and a bodily fluid or bodily-fluid substitute.

Acoustic feedback is precluded by virtue of the fact that neither acoustic signals nor mechanical vibrations are generated in the hearing aid or in the housing of the hearing aid in the vicinity of the microphone. In particular, it is precisely persons who are severely hard of hearing who can be supplied with signals that accordingly have a higher volume, without the higher volume further increasing a tendency toward feedback.

As a result of the lack of a mechanical or acoustic vibration generator and lack of a receiver, problems with an adverse effect on same as a result of physical influences such as contamination are precluded. A contamination of the transmitter like in the case of the receiver in the auditory canal can also be precluded because the magnetic transmitter requires no sound outlet opening.

Problems with deteriorating connections at contact points to the body are likewise precluded by the contactless signal transmission. The magnetic transmitter is not subject to such influences and therefore ensures a significantly longer durability in application. On the other hand, contaminations or deteriorations would also be insignificant because they would hardly influence the transmission of the magnetic field.

Not least, a hearing-aid solution is advantageously also provided independently of the normal, healthy functionality of the middle-ear apparatus. Moreover, this also allows an open solution despite a high degree of hearing loss, which would otherwise assume a closed solution in order to generate a sufficient sound pressure.

It goes without saying that use of the system is not only conceivable on the human body, but also on the body of any other living being, provided it has a comparably designed hearing apparatus.

A further basic idea of the invention consists of a hearing aid, which comprises a signal processing device and a magnetic transmitter connected thereto. As per this basic idea, the magnetic transmitter transmits a magnetic field, by means of which vibrations, which are suitable for triggering an auditory perception in a human cochlea, are generated in a liquid mixture containing a magnetofluid, which is suitable for use within the human body, and a bodily fluid or bodily-fluid substitute.

Such a hearing aid has the advantages described above. Moreover, the functionality of the magnetic transmitter is not dependent to the same high degree on the exact and stable positioning as is the case in conventional receivers.

It goes without saying that use of the hearing aid is not only conceivable on the human body, but also on the body of any other living being, provided it has a comparably designed hearing apparatus.

In an advantageous development of the basic idea of the invention, the magnetic transmitter is arranged in a housing of the hearing aid. This makes it possible to achieve a compact design in a single component, which is easy to handle and wear.

In a further advantageous development, the magnetic transmitter is connected to a housing of the hearing aid via a tube and designed to be positioned in a human auditory canal. Positioning the transmitter in the auditory canal ensures a short distance to the cochlea and so provision can be made for the acoustic needs of the hearing-aid user with relatively low transmission power of the magnetic transmitter. The low transmission power helps saving electrical energy, which is particularly advantageous in the case of portable hearing aids that rely on a voltage supply by batteries. Moreover, the short distance between transmitter and cochlea reduces the susceptibility to faults as a result of transmission obstacles or interference signals.

In a further advantageous development, the magnetic transmitter is designed to be implanted subcutaneously. This ensures a particularly stable position of the transmitter, which ensures a high reliability and a lack of susceptibility to faults of the transmission to the cochlea. Moreover, it is precisely the option of permanently using the transmitter as a result of its low susceptibility to wear and tear that allows the subcutaneous implantation, which would hardly be feasible in the case of a transmitter that needs to be replaced frequently.

Further advantageous developments emerge from the dependent patent claims and from the subsequent description of exemplary embodiments using the figures. In detail:

FIG. 2 shows a magnetofluidic hearing-aid system,

FIG. 3 shows a hearing-aid system with a BTE housing,

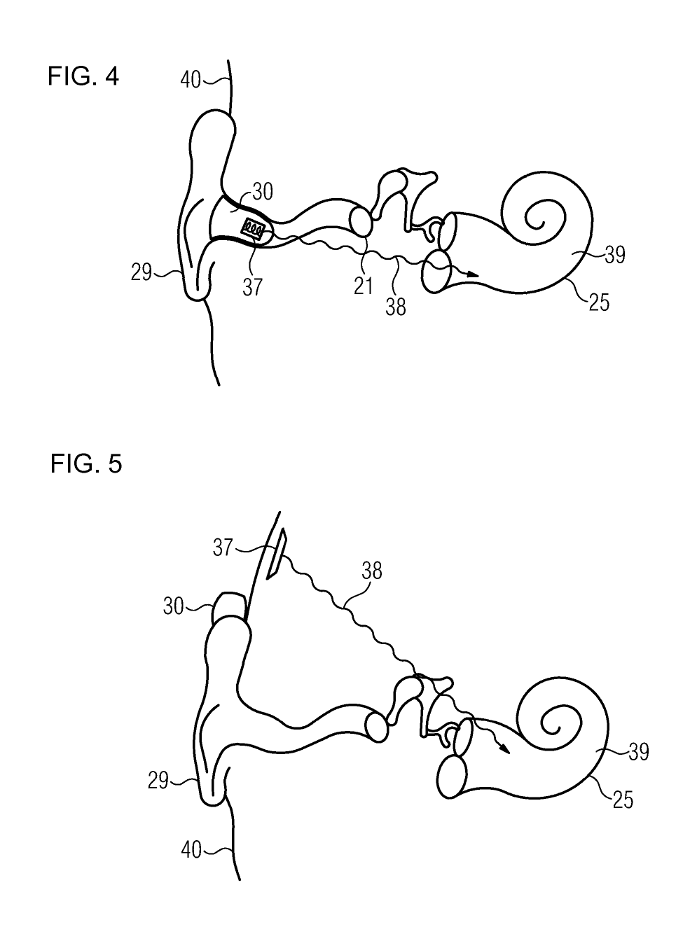

FIG. 4 shows a hearing-aid system with an ITE housing, and

FIG. 5 shows a hearing-aid system with a subcutaneously implanted transmitter.

FIG. 2 schematically illustrates a magnetofluidic hearing-aid system with a hearing aid 30 and the human hearing apparatus 20. The hearing aid 30 comprises a microphone 35, which converts acoustic signals from the surroundings into electric signals. The signals are fed to the signal device 36, which undertakes processing dependent on user inputs, the respectively active processing algorithm and further parameters. The processed and optionally amplified signal is fed to the magnetic transmitter 37.

The magnetic transmitter 37 generates a magnetic field, which is illustrated by a snaking arrow 38. The magnetic field is emitted by the transmitter 37 in a preferred direction and the transmitter 37 is placed such that the cochlea 25 is situated in this preferred direction.

The magnetic field is transmitted independently of interjacent components of the human hearing apparatus, namely the eardrum 21, the malleus 22, incus 23 or the stirrup 24. There is no mechanical or acoustic signal generation in the transmitter 37. Rather, a vibration state is generated directly within the cochlea 25, which vibration state allows auditory perception by the organ of Corti or the hair cells.

In the natural state, the cochlea 25 with the oval window 26 and the round window 27 is filled with bodily fluids, namely with endolymph and perilymph. The endolymph and perilymph are routed in a three-channel tube system (not illustrated) within the cochlea 25 and the perilymph is in contact with the hair cells. Vibration states of the perilymph are detected by the hair cells and thus generate auditory perception.

In the illustrated exemplary embodiment, the cochlea is not only filled with bodily fluids, but rather a magnetofluid has been mixed into the perilymph. The magnetofluid is biocompatible, i.e. suitable for use in the human body, and is introduced into the cochlea by surgery.

A magnetofluid or ferrofluid refers to a liquid that reacts to a magnetic field. Magnetofluids consist of a few nanometer-sized magnetic particles, which are suspended in a carrier liquid in a colloidal fashion. The solid particles are generally stabilized with a polymer surface coating. It is important that magnetofluids are stable as a dispersion, i.e. that the solid particles are not deposited over time or do not accumulate in extremely strong magnetic fields or precipitate out of the liquid phase.

Magnetofluids are known from diverse fields of application. By way of example, magnetite (Fe₃O₄) can be used as carrier for the magnetic particles, or else cobalt-nickel- or Fe-, Co- or FeCO-compounds. Although hydrocarbons or fluorinated hydrocarbons can be used as carrier liquid, water is used in particular for biocompatible magnetofluids. The composition must take into account the usability in the human body, wherein experience with magnetofluids from imaging medical technology, where said magnetofluids are also used as a contrast agent, can also be taken into account.

The liquid mixture with the magnetofluid in the cochlea forms a uniform mixture and has the property of being able to be excited by external magnetic fields. This allows the magnetic transmitter 37, or the magnetic field therefrom, to excite the cochlea into vibration states, equivalent to an acoustic excitation, in order thereby to trigger auditory perception in the hearing-aid user. The vibration states advantageously do not differ from vibration states triggered by acoustic signals from the surroundings, i.e. the vibration states induced in the cochlea 25 by the transmitter 37 correspond to those that would otherwise be induced by the middle-ear apparatus.

The magnetofluid is added to the perilymph in the cochlea 25 in suitable quantities in order to be able to induce vibration states by the field that can be generated by the transmitter 37 and more particularly by the possible field strengths. Moreover, a carrier liquid with a viscosity that is matched to the perilymph is advantageously used for the magnetofluid such that the vibration properties of the perilymph are not changed, or only changed by an insubstantial amount. This keeps the natural auditory properties as intact as possible. In a further exemplary embodiment it would also be feasible to replace the perilymph by a fluid which replaces the former as a bodily-fluid substitute and into which magnetofluid components have been mixed.

FIG. 3 illustrates a magnetofluidic hearing-aid system with a BTE hearing-aid housing. The hearing aid 30 is designed as a BTE aid in terms of its housing shape and is worn behind the ear 29. However, a tube 31 does not connect the hearing aid 30 to a receiver but rather to the magnetic transmitter 37, with the tube routing electrical lines (not illustrated). Tube 31 and sensor 37 are sufficiently narrow or have a small enough diameter that the auditory canal remains unblocked. As a result, an open solution is achieved and the occurrence of occlusion effects is prevented.

The transmitter 37 is placed such that it emits a magnetic field substantially in the direction of the cochlea 25, which is illustrated by a snaking arrow 38. The eardrum 21 and the further parts of the middle-ear apparatus are not impinged upon by acoustic signals by the transmitter 37. Rather, the output signal from the transmitter 37 is used for directly inducing vibration states within the cochlea 25 in the liquid mixture 39 located there. Additional impingement by acoustic signals that are routed to the eardrum 21 is not required for the functionality of the embodiment described in an exemplary fashion; however, this would not be an impediment. The same holds true for the preceding exemplary embodiment and for the following exemplary embodiments.

FIG. 4 describes a constellation that resembles the preceding ones; however, the hearing aid 30 is embodied as an ITE aid. Apart from that, equivalent components are illustrated as in the preceding description of the figures and are denoted by the same reference signs.

FIG. 5 illustrates an exemplary embodiment with a modified configuration. The hearing aid 30 is embodied as a BTE aid and worn behind the ear 29. The magnetic transmitter 37 is implanted subcutaneously below the scalp 40. The connection between hearing aid 30 and transmitter 37 has not been illustrated; it can be provided wirelessly or by a connection cable. Apart from that, the illustrated configuration of hearing aid 30 and transmitter 37 resembles a configuration that is conventional in cochlea implants.

However, the transmitter 37 interacts with the liquid mixture 39 within the cochlea 25 via a magnetic field, illustrated as a snaking arrow 38 in FIG. 5, as described above.

A basic idea of the invention can be summarized as follows: the invention relates to a magnetofluidic hearing-aid system and to a hearing aid for use in such a hearing-aid system. The hearing aid 30 comprises a signal processing device 36 and a magnetic transmitter 37 connected thereto. The system comprises such a hearing aid 30 and a magnetofluid, wherein the magnetofluid is suitable for use within the body. As per the basic idea of the invention, the magnetic transmitter 37 transmits a magnetic field, by means of which vibrations are generated in a liquid mixture containing the magnetofluid. The liquid mixture is introduced into a cochlea by surgery and the vibrations are suitable for triggering an auditory perception in the cochlea. Acoustic feedback is precluded by virtue of the fact that neither acoustic signals nor mechanical vibrations are generated by the transmitter 37. Adverse effects on the functionality by physical influences such as contamination, as e.g. in an acoustic receiver, are also precluded. Problems with deteriorating contact to the body are already suppressed from the outset by the contactless signal transmission. Not least, a hearing-aid solution is advantageously also made possible independently of the functionality of the middle-ear apparatus.

1-5. (canceled)

6. A system, comprising:
a liquid mixture containing a magnetofluid suitable for use within the body and a bodily fluid or bodily-fluid substitute; and
a hearing aid having a signal processing device and a magnetic transmitter connected to said signal processing device;
said magnetic transmitter transmitting a magnetic field interacting with said magnetofluid and generating vibrations in said liquid mixture suitable for triggering an auditory perception in a cochlea.

7. A hearing aid, comprising:
a signal processing device and a magnetic transmitter connected to said signal processing device;
said magnetic transmitter transmitting a magnetic field generating vibrations in a liquid mixture suitable for triggering an auditory perception in a cochlea, the liquid mixture containing a magnetofluid suitable for use within the body and a bodily fluid or bodily-fluid substitute.

8. The hearing aid according to claim 7, which further comprises a hearing aid housing in which said magnetic transmitter is disposed.

9. The hearing aid according to claim 7, which further comprises a hearing aid housing and a tube, said magnetic transmitter being connected to said hearing aid housing by said tube and being configured to be positioned in an auditory canal.

10. The hearing aid according to claim 7, wherein said magnetic transmitter is configured to be implanted subcutaneously.
